(19) United States
(12) Patent Application Publication
(10) Pub. No.: US 2018/0197347 A1
(43) Pub. Date: Jul. 12, 2018

(54) MANAGING VIRTUAL REALITY OBJECTS

(71) Applicant: Taqtile, Seattle, WA (US)

(72) Inventor: John Tomizuka, Seattle, WA (US)

(21) Appl. No.: 15/868,998

(22) Filed: Jan. 11, 2018

Related U.S. Application Data
(60) Provisional application No. 62/445,159, filed on Jan. 11, 2017.

(51) Int. Cl. G06T 19/20; G06T 19/00; G06F 3/0481; H04L 29/08

(52) U.S. Cl. CPC G06T 19/20; H04L 67/306; G06F 3/04815; G06T 19/003

(57) ABSTRACT

Systems and methods are described for managing virtual reality (VR) and augmented reality (AR) objects, such as avatars. When an avatar is instantiated, a tracking file on a client is associated with an avatar component. When changes are made with respect to the avatar—i.e., a method is called, an event is triggered, an attribute is changed—the tracking module traps the change (i.e., the function making the change and its parameters) and transmits the function and parameters to a server, which hosts several resources. The server receives the function and parameters and refers to a concordance database to look up a generic class to which the function has been mapped. If an event handler is available for the function, then the server executes the event handler and transmits a result to the client. An audit can be performed on classes used with an avatar.

### CROSS-REFERENCE TO RELATED APPLICATION

This application is related to, and claims priority to, U.S. provisional patent application Ser. No. 62/445,159, entitled Three-Dimensional Body Modeling for Virtual Reality Space, filed Jan. 11, 2017.

### BACKGROUND

Virtual reality (VR) is a computer technology that uses projected environments to generate realistic images, sounds and other sensations that simulate a user's physical presence in a virtual or imaginary environment. A person using virtual reality equipment is able to “look around” the artificial world, and with high quality VR, move around in it and interact with virtual features or items. The effect is commonly created by VR headsets consisting of a head-mounted display with a small screen in front of the eyes, but can also be created through specially designed rooms with multiple large screens.

Augmented reality (AR) is a live direct or indirect view of a physical, real-world environment whose elements are “augmented” by computer-generated or extracted real-world sensory input such as sound, video, graphics, haptics or GPS data. It is related to a more general concept called computer-mediated reality, in which a view of reality is modified (possibly even diminished rather than augmented) by a computer. Augmented reality enhances one's current perception of reality, whereas virtual reality replaces the real world with a simulated one. Augmented reality is used in order to enhance the experienced environments or situations and to offer enriched experiences. Originally, the immersive augmented reality experiences were used in entertainment and game businesses, but now other business industries are also getting interested about AR's possibilities for example in knowledge sharing, educating, managing the information flood and organizing distant meetings. Augmented reality has a lot of potential in gathering and sharing tacit knowledge. [4] Augmentation techniques are typically performed in real time and in semantic context with environmental elements, such as overlaying supplemental information like scores over a live video feed of a sporting event.

Mixed reality (MR), sometimes referred to as hybrid reality, is the merging of real and virtual worlds to produce new environments and visualizations where physical and digital objects co-exist and interact in real time. Mixed reality takes place not only in the physical world or the virtual world, but is a mix of reality and virtual reality, encompassing both augmented reality and augmented virtuality via immersive technology.

To avoid confusion, the present description uses the term “XR” to reference virtual reality, augmented reality, mixed reality, etc. The term “XR is meant to cover all virtual environment modes ((X)R=VR, MR, AR, etc.) used herein. For purposes of the present discussion, any reference to one of the terms VR, AR, MR), or XR is to be construed as a reference to any other or all of the terms.

The present description also references the word “avatar,” as used in the field of computing technology. In computing, an avatar is a graphical representation of a user or the user's alter ego or character, frequently used in the context of video games, social networking, etc. As virtual world and XR universe technology has rapidly advanced, the introduction of three-dimensional (3-D) avatars has become popular with users. With this growth, a need has arisen to manage avatars and the data, metadata, and functions associated with them.

### BRIEF DESCRIPTION OF THE DRAWINGS

The detailed description is described with reference to the accompanying figures, in which the left-most digit(s) of a reference number identifies the figure in which the reference number first appears. The use of the same reference numbers in different figures indicates similar or identical items.

FIG. 1 is a diagram of an example computer network environment within which the techniques described herein may be practiced.

FIG. 2 is a block diagram of an example client computing device in which the technological solutions described herein may be implemented.

FIG. 3 is a block diagram of an example server in accordance with the technologies described herein.

FIG. 4 is an illustration of an example user profile table as described herein.

FIG. 5 is an illustration of an example avatar profile table in accordance with the present description.

FIG. 6 is an illustration of an example concordance in accordance with the present description.

FIG. 7 is an illustration of an example history table in accordance with the present description.

FIG. 8 is a flow diagram of an example methodological implementation of a method for managing virtual/augmented reality (XR) objects.

FIG. 9 is a flow diagram of an example methodological implementation of a method for managing virtual/augmented reality (XR) objects.

### DETAILED DESCRIPTION

The present disclosure relates to managing virtual/augmented reality objects. More particularly, the present disclosure relates to tracking changes made to an avatar component and providing a concordance function and an auditing function related to virtual/augmented reality objects. While the present description may focus on particular uses of avatars in certain contexts, the described technology may be used in any suitable XR environment. The described techniques may be used in a process to create an avatar, and they can be used in a process to select and use a pre-existing avatar. Also, although the present discussion is made with reference to “avatars,” the described technology may be used with characters or objects that are not commonly known as avatars. Therefore, as used herein, the term “avatar” may be equated with the term “character” or the term “object.” Any of these terms can refer to a virtual “being” that works within an XR environment and represents a user or some other entity.

### Example Computer Network Environment

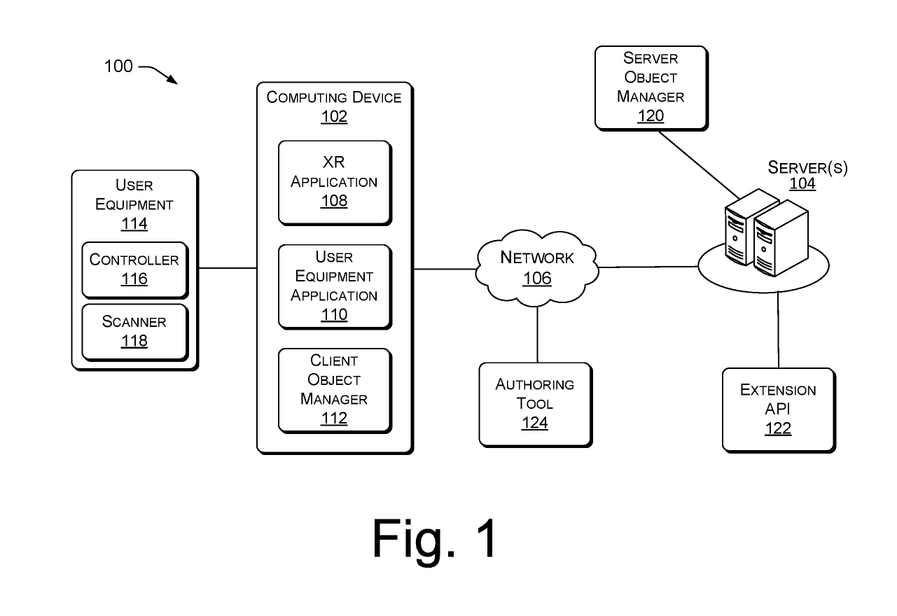

FIG. 1 is a diagram of an example computer network environment 100 within which the techniques described herein may be practiced. The diagram is meant to merely represent a high-level of elements and features to describe an operating environment. Further details are shown and described, below, with respect to subsequent figures.

The example computer network environment 100 includes a client computer device 102 and one or more servers 104 that are each in communication with a common network 106. The network 106 may be a public network, such as the Internet, or it may be a private network, such as a local area network (LAN) in an enterprise environment. Any network that can accommodate communications between the client computer device 102 and the one or more servers 104 may be implemented.

The client computing device 102 includes an XR application 108, a user equipment application 110, and a client object manager 112. User equipment 114 communicates with the client computing device 102, and includes any equipment that can be used by a user to communicate with the client computing device 102 and/or its elements. As shown, the user equipment 114 includes a controller 116 and a scanner 118. The controller 116 is a three-dimensional (3-D) controller that may be used with the XR application 108. Examples of controllers include, but are not limited to, a HoloLens®device, an Oculus Rift® device, a Project Tango® device, a Daydream® device, a Cardboard® device, a smart phone, or the like. Any device that is capable of rendering a 3-D image will suffice for the controller 116. The scanner 118 is an electronic device that is used to scan a user, another person, an object, a part of an environment (such as a room in which it is situated), etc. The resulting scanned image may be used to create an avatar. Examples of scanners include, but are not limited to an Intel® RealSense® camera, a Microsoft® Kinect® camera, a Samsung® NX300® camera, a Fujifilm® FinePix® camera, a smart phone camera, or the like. A scanner may be a dual lens device, or a single lens device that changes a position of the lens to capture a 3-D image.

The one or more servers 104 include at least a server object manager 120 and an extension API 122 that is accessible by third parties. The server object manager 120 and the client object manager 112 are configured to cooperate to implement the techniques described herein. The server object manager 122 and the client object manager 112 are described in greater detail, below. Finally, the example computer network environment 100 includes an authoring tool 124 that may be used to create an avatar. Any 3-D authoring program, such Autodesk® 3ds Max®, Autodesk® Maya®, Autodesk® SoftImage®, Pixologic® Zbrush®, Luxology® Modo®, Blender®, etc.

As will be described in greater detail, below, as a user is using the user equipment 114 to interface with the executing XR application 108, the client object manager 112 is implemented to intercept actions between the two. Specifically, the client object manager 112 intercepts method calls, event triggers, and attribute changes made by the controller 116 or the XR application 108 to methods, events, and attributes of an avatar operating within the XR application 108.

### Example Client Computing Device

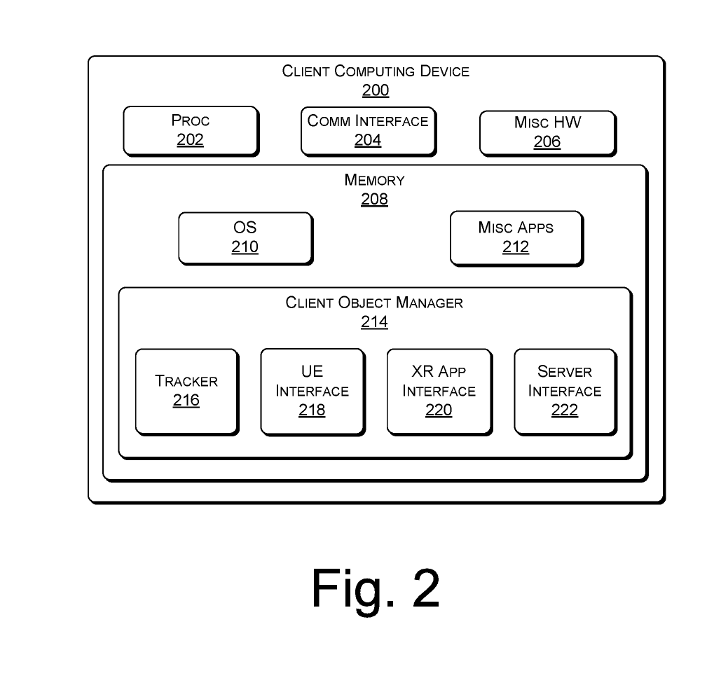

FIG. 2 is a block diagram of an example client computing device 200 in which the technological solutions described herein may be implemented. The example client computing device 200 depicts an exemplary hardware, software and communications environment. FIG. 2 illustrates several possible embodiments of a hardware, software and communications environment 200 for managing XR objects.

The example client computing device 200 can be almost any computing device. Exemplary user devices include without limitation various personal computers, tablet computers, smart phones, and the like. The client computing device 200 includes one or more processors 202 that include electronic circuitry that executes instruction code segments by performing basic arithmetic, logical, control, memory, and input/output (I/O) operations specified by the instruction code. The processor 202 can be a product that is commercially available through companies such as Intel® or AMD®, or it can be one that is customized to work with and control and particular system.

The example client computing device 200 also includes a communications interface 204 and miscellaneous hardware 206. The communication interface 204 facilitates communication with components located outside the example client computing device 200, and provides networking capabilities for the example client computing device 200. For example, the example client computing device 200, by way of the communications interface 204, may exchange data with other electronic devices (e.g., laptops, computers, servers, etc.) via one or more networks (FIG. 1, 106). Communications between the example client computing device 200 and other electronic devices may utilize any sort of communication protocol known in the art for sending and receiving data and/or voice communications.

The miscellaneous hardware 206 includes hardware components and associated software and/or or firmware used to carry out device operations. Included in the miscellaneous hardware 206 are one or more user interface hardware components not shown individually—such as a keyboard, a mouse, a display, a microphone, a camera, and/or the like—that support user interaction with the example client computing device 200.

The example client computing device 200 also includes memory 208 that stores data, executable instructions, modules, components, data structures, etc. The memory 208 is be implemented using computer readable media. Computer-readable media includes at least two types of computer-readable media, namely computer storage media and communications media. Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. Computer storage media may also be referred to as “non-transitory” media. Although, in theory, all storage media are transitory, the term “non-transitory” is used to contrast storage media from communication media, and refers to a component that can store computer-executable programs, applications, and instructions for more than a few seconds. In contrast, communication media may embody computer readable instructions, data structures, program modules, or other data in a modulated data signal, such as a carrier wave, or other transmission mechanism. Communication media may also be referred to as “transitory” media, in which electronic data may only be stored for a brief amount of time, typically under one second.

An operating system 210 is stored in the memory 208 of the example client computing device 200. The operating system 210 controls functionality of the processor 202, the communications interface 204, and the miscellaneous hardware 206. Furthermore, the operating system 210 includes components that enable the example client computing device 200 to receive and transmit data via various inputs (e.g., user controls, network interfaces, and/or memory devices), as well as process data using the processor 202 to generate output. The operating system 210 can include a presentation component that controls presentation of output (e.g., display the data on an electronic display, store the data in memory, transmit the data to another electronic device, etc.). Additionally, the operating system 210 can include other components that perform various additional functions generally associated with a typical operating system. The memory 208 also stores various software applications 212, or programs, that provide or support functionality for the example client computing device 200, or provide a general or specialized device user function that may or may not be related to the example client computing device 200 per se.

The memory 208 also stores a client object manager 214 (similar to the client object manager 112 shown in FIG. 1). The client object manager 214 includes executable code segments that are used in accordance with the present description, to capture changes to an avatar in an XR application 108 (FIG. 1). The client object manager 214 includes a tracker 216 that mediates between a UE interface 216 to the user equipment application 110 (FIG. 1) and an XR application interface 220 to the XR application 108. In such an implementation, the tracker 216 can intercept functions (i.e., calls, events, attribute changes, etc.) that go between the user equipment 114 (FIG. 1) and the XR application 108. The client object manager 214 also includes a server interface 222 that provides a connection to the one or more servers 120 (FIG. 1). The server interface 222 is used to report intercepted data to the one or more servers 120.

Further features of the example computing device 200, including the client object manager 214 will be explained further, below, with respect to subsequent features.

### Example Server

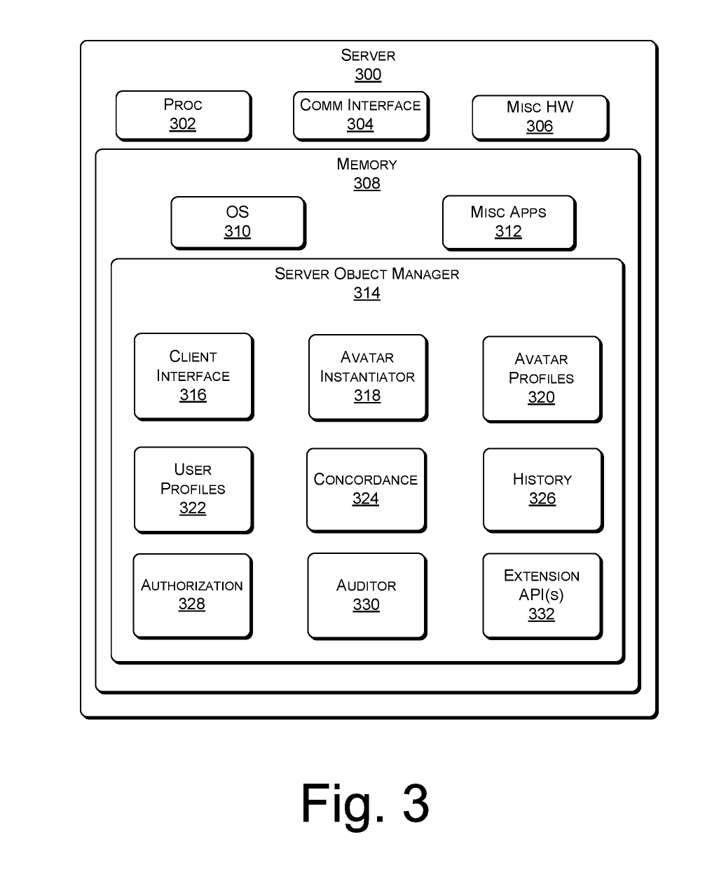

FIG. 3 is a block diagram of an example server 300 in which the technological solutions described herein may be implemented. The example server 300 depicts an exemplary hardware, software and communications environment. FIG. 3 illustrates several possible embodiments of a hardware, software and communications environment 300 for managing XR objects.

The example server 300 includes at least one processor 302 that include electronic circuitry that executes instruction code segments by performing basic arithmetic, logical, control, memory, and input/output (I/O) operations specified by the instruction code. The processor 302 can be a product that is commercially available through companies such as Intel® or AMD®, or it can be one that is customized to work with and control and particular system.

The example server 300 also includes a communications interface 304 and miscellaneous hardware 306. The communication interface 304 facilitates communication with components located outside the example server 300, and provides networking capabilities for the example server 300. For example, the example server 300, by way of the communications interface 304, may exchange data with electronic devices (e.g., laptops, computers, servers, etc.) via one or more networks 106 (FIG. 1). Communications between the example server 300 and other electronic devices may utilize any sort of communication protocol known in the art for sending and receiving data and/or voice communications.

The miscellaneous hardware 306 includes hardware components and associated software and/or or firmware used to carry out device operations. Included in the miscellaneous hardware 306 are one or more user interface hardware components not shown individually—such as a keyboard, a mouse, a display, a microphone, a camera, and/or the like—that support user interaction with the example server 300.

The example server 300 also includes memory 308 that stores data, executable instructions, modules, components, data structures, etc. The memory 308 is be implemented using computer readable media. Computer-readable media includes at least two types of computer-readable media, namely computer storage media and communications media. Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. Computer storage media may also be referred to as “non-transitory” media. Although, in theory, all storage media are transitory, the term “non-transitory” is used to contrast storage media from communication media, and refers to a component that can store computer-executable programs, applications, and instructions for more than a few seconds. In contrast, communication media may embody computer readable instructions, data structures, program modules, or other data in a modulated data signal, such as a carrier wave, or other transmission mechanism. Communication media may also be referred to as “transitory” media, in which electronic data may only be stored for a brief amount of time, typically under one second.

An operating system 310 is stored in the memory 308 of the example server 300. The operating system 310 controls functionality of the processor 302, the communications interface 304, and the miscellaneous hardware 306. Furthermore, the operating system 310 includes components that enable the example client computing device 300 to receive and transmit data via various inputs (e.g., user controls, network interfaces, and/or memory devices), as well as process data using the processor 302 to generate output. The operating system 310 can include a presentation component that controls presentation of output (e.g., display the data on an electronic display, store the data in memory, transmit the data to another electronic device, etc.). Additionally, the operating system 310 can include other components that perform various additional functions generally associated with a typical operating system. The memory 308 also stores various software applications 312, or programs, that provide or support functionality for the example server, or provide a general or specialized device user function that may or may not be related to the example server 300 per se.

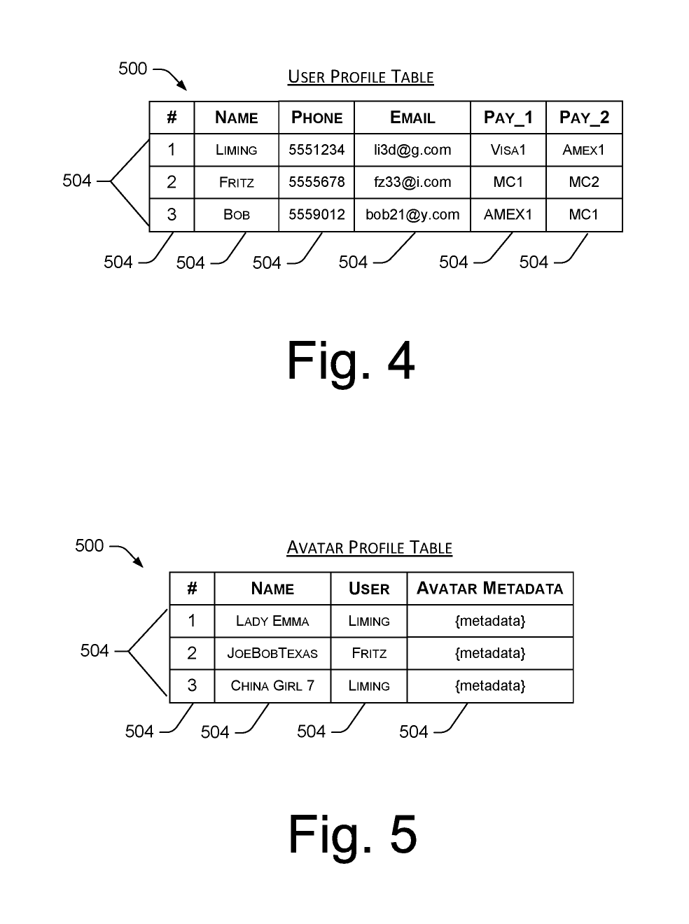

The memory 308 also stores a server object manager 314 (similar to the server object manager 120 shown in FIG. 1). The server object manager 314 includes executable code segments that are used in accordance with the present description, to receive changes related to an avatar in an XR application 108 (FIG. 1). The server object manager 314 includes a client interface 316 that communicates with the server interface 222 (FIG. 2) of the example client computing device 200 (FIG. 2). Through this connection, the server object manager 314 receives data intercepted by the tracker 216, which it uses to execute various operations, described in more detail, below. The server object manager 314 also includes an avatar instantiator 318. The avatar instantiator 318 is configured to receive data input by the scanner 118 and to create an avatar from the data. The data may enable creation of a full-body avatar, or it may enable creation of a partial-body avatar, such as an avatar that is an image of a user's head and/or face. The avatar instantiator 318 may also receive an avatar selected by a user from a set of pre-existing avatars. As described below, the avatar instantiator 318 is configured to establish avatar profiles 320 and link them with user profiles 322, which are store on the example server 300 or on an external memory storage device. Wherever the user profiles 322 and the avatar profiles 320 are stored, the sever object manager 314 is able to access the information contained therein. Example of the avatar profiles 320 and the user profiles 322 are shown below, with regard to FIGS. 4 and 5, respectfully.

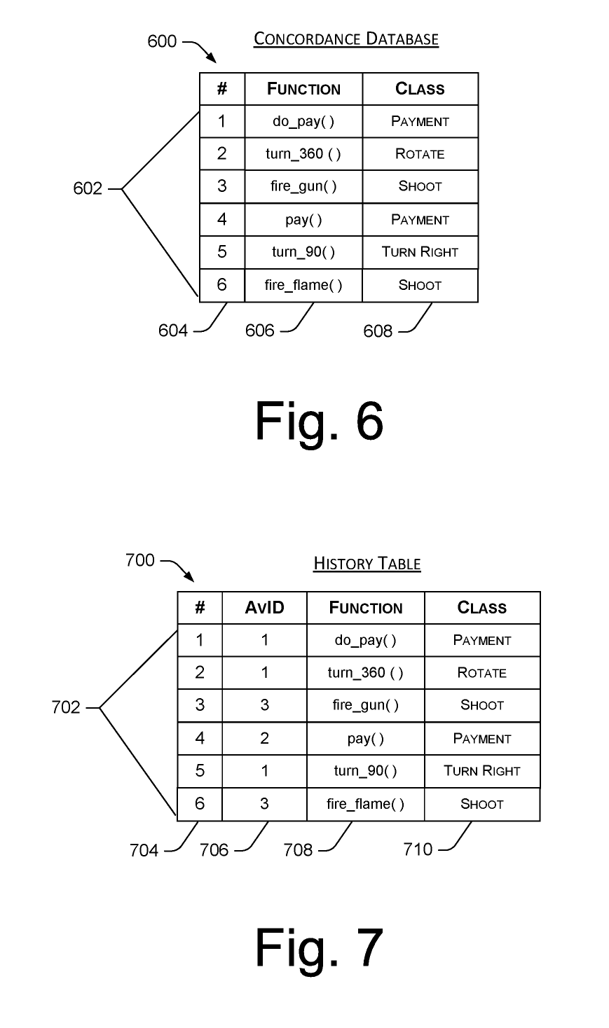

The example server 300 also includes a concordance 324. The concordance 324 (shown below with respect to FIG. 6) binds application-specific function names to generic class names. To enable the server object manager 314 and the client object manager 214 (FIG. 2) to work interchangeably with various XR applications, the concordance provides a list of function names that are used in the various XR applications. Associated with each of the listed function names, are generic class names that have a particular meaning within the server object manager 314 and the client object manager 214. As a result, a first XR application may have a function name for activating a weapon called “fire_gun( ),” while a second XR application may have a function name for activating a weapon called “fire_flames( ).” Although the functions have different names, they perform the same (or similar) operation. The concordance 324 is used to convert the respective application function names to a generic class that is recognizable by the server object manager 314 and the client object manager 214, such as “shoot( ).” Further examples of the concordance 324 and it's elements are shown and described below.

The server object manager 314 also includes a history 326 where the server object manager 314 can store avatar functions (method calls, event triggers, etc.) as they occur, so that an auditable record is created of the avatar's actions. When an intercepted function is transmitted from the client object manager 214 to the server object manager 314, the server object manager 314 creates a record in the history 326 that identifies at least the avatar associated with the intercepted function and the intercepted function. In at least one implementation, the generic class associated with the intercepted function (found via the concordance 324) is also stored in the history 326. An example history table is shown and described with respect to FIG. 7, below.

An authorization module 328 is also included in the server object manager 314 and can be configured to request user authorization when certain generic class functions are invoked. For example, if the server object manager 314 receives an XR application function name and looks it up in the concordance 324, it may find that the function name resolves to a generic class such as “payment( ).” In such a case, it may be desirable for the user to authorize anything to do with a “payment” before proceeding. In such a case, a message is provided via the user equipment interface 218 (FIG. 2) of the client object manager 214, where a user can authorize or decline the request.

The example server 300 also includes an auditor 330 that is configured to collect data from various locations on the example server 300. For example, a user may want to run a report on all functions related to a specific avatar. In that case, the server object manager 314 can pull all entries from the history 326 related to the specified avatar. Or if the user wants to see any function related to a “payment” function with all avatars associated with the user, the server object manager 314 can gather the data from various locations, such as from the user profiles 320, the avatar profiles 322, and the history 326.

Finally, the server object manager 314 includes one or more extension APIs 332 (application programming interfaces). Extension APIs 332 are provided so that a third party may access the server object manager 314 to perform a function of one of the elements shown herein. For example, a third party may maintain a comprehensive concordance of all functions used by the most-used XR applications. Rather than trying to repeat this work, the server object manager 314 may simply refer to an external concordance that uses one of the extension APIs 332. In addition, a third-party application may use the extension APIs 332 to provide a function that is not described herein.

### Example User Profile Table

FIG. 4 is an illustration of an example user profile table 400 as described herein (e.g., user profiles 320 (FIG. 3)). The user profile table 400 includes multiple records 402, which each include multiple fields, to-wit: a record number field 404, a name field 406, a phone number field 408, an email field 410, a first payment method field 412, and a second payment method field 414. Alternate implementations may include more, fewer, or different fields in each record. The fields shown in FIG. 4 are by way of example only.

A user name is stored in each record, the user name being associated with an owner of one or more avatars. Each record also include information about the user. Here, the information about the user includes the user's contact phone number, the user's email address, and multiple payment methods authorized by the user. By maintaining the user profile table 400, all information related to user may be stored in a single location. Therefore, when a user needs to edit data related to multiple avatars, the user only needs to change the information in one place, and the changes will be associated with each avatar owned by the user.

### Example Avatar Table

FIG. 5 is an illustration of an example avatar profile table 500 in accordance with the present description. The example avatar table 500 includes multiple records 502, which each include multiple fields, to-wit: a record number field 504, an avatar name field 506, a user name field 508, and an avatar metadata field 510. Alternate implementations may include more, fewer, or different fields in each record. The fields shown in FIG. 5 are by way of example only.

In the described implementation, the example avatar profile table 500 associates each avatar owned by a user with that user, and the metadata that is associated with the avatar. For example, record number one 504 indicates that an avatar named “Lady Emma” is owned by user “Liming.” The user field 508 may contain a literal, or it more likely contains a reference to the user name field 406 associated with “Liming” in the user profile table 400. As shown in record number three, “Liming” also owns an avatar names “China Girl.” The user name field 508 associated with “China Girl” also references the information stored for “Liming” in the user profile table. By linking the user profile table 400 and the avatar profile table 500 in this manner, only one instance of personal identifying user data needs to be stored.

### Example Concordance

FIG. 6 is an illustration of an example concordance 600 in accordance with the present description. The example concordance 600 includes multiple records 602, which each include multiple fields, to-wit: a record number field 604, a function name field 606, a generic class field 608. Alternate implementations may include more, fewer, or different fields in each record. The fields shown in FIG. 6 are by way of example only. The function name field 606 in each record 602 stores a function name used in an XR application (such as XR Application 108 in FIG. 1). A generic class name associated with each function name field 606 is stored in the generic class field 608. In the present example, it can be seen the an application function named “do_pay( )” is associated with a generic class of “Payment( ).” It can also be seen that another application function (from a different XR application) with the name of “pay( )” also resolved to the generic class of “Payment( ).” Other function names are associated with one or more other generic class names. This allows the server object manager 314 and the client object manager 214 to manipulate an avatar in a similar way even when different function names are used.

### Example History Table

FIG. 7 is an illustration of an example history table 700 in accordance with the present description. The example history table 700 includes multiple records 702, which each include multiple fields, to-wit: a record number field 704, an avatar identifier field 706, a function name field 708, and a generic class field 710. Alternate implementations may include more, fewer, or different fields in each record. The fields shown in FIG. 7 are by way of example only.

As described below, when the server object manager 314 receives a notification of a function that has been intercepted, the server object manager 314 starts a record in the history table 700. In that record, information identifying the avatar associated with the intercepted function is stored, together with the function name that was intercepted and, in at least one implementation, the generic class name associated with the intercepted function name in the concordance 600 (FIG. 6). Storing all interactions with each avatar provides an auditable database for all such interactions.

### Example Methodological Implementation

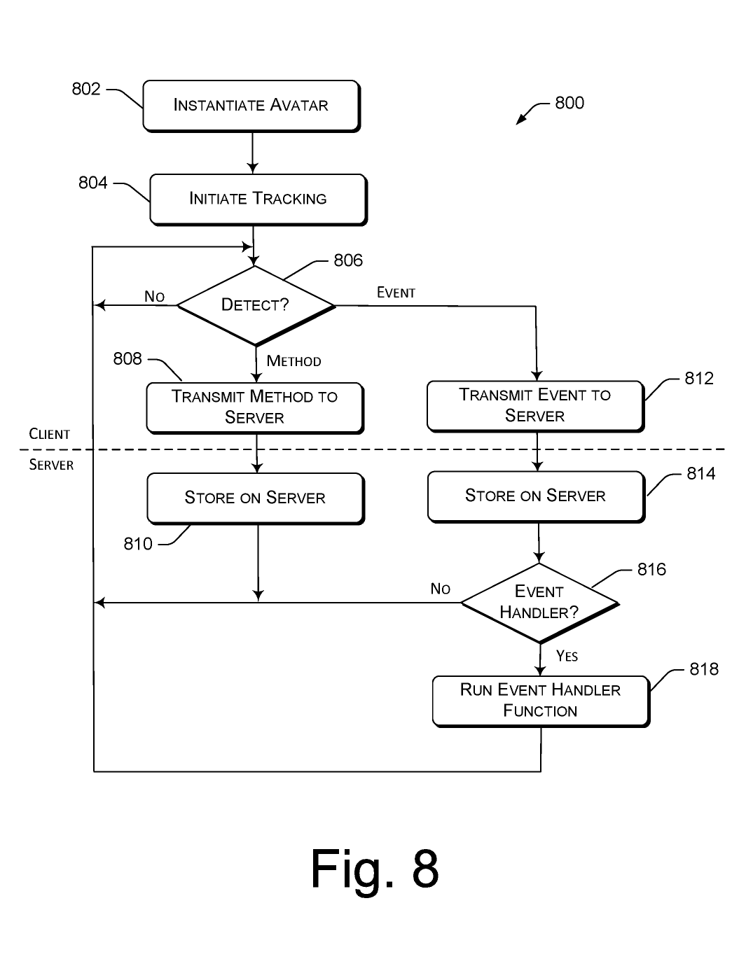

FIG. 8 is a flow diagram 800 of an example methodological implementation of a method for managing virtual/augmented reality (XR) objects. In the following discussion of FIG. 8, continuing reference is made to elements and reference numerals shown in and described with regard to previous figures. It is noted that, although certain operations are attributed to certain diagram boxes, those skilled in the art will recognize that some operations may be performed together with other steps shown in other boxes and that certain operations may be divided or combined. Operations shown may be performed in hardware components, software components, firmware, or a combination thereof.

At block 802, an avatar is instantiated by a user. Typically, a user will make a selection with the controller 116 (FIG. 1) to select or create an avatar. The selection may be made through the XR application 108 or the client object manager 112 in communication with the server object manager 120. However, the process is initiated, the avatar instantiator 318 (FIG. 3) creates an avatar and associates the avatar with a user file 320 and an avatar profile 322. At block 804, the tracker 216 (FIG. 2) initiates interception of activity between the avatar and the user equipment 114 controller 116, and between the avatar and the XR application 108.

If the tracker 216 detects a method call from the XR application 108 (“Method” branch, block 806), then the tracker 216 transmits the relevant method to the server object manager 314, including the method name and its parameters, at block 808. The server object manager 314 saves the transmitted method data to the concordance 324 and to the history 326 at block 810. The process then continues to monitor the activity between the avatar and the controller 116.

If the tracker 216 detects an event trigger from the controller 116 (“Event” branch, block 806), then the tracker transmits the relevant event name and its parameters to the server object manager 314 at block 812. The server object manager 314 saves the transmitted event data to the concordance 324 and to the history 326 at block 814. At block 816, the server object manager 314 determines if there is an event handler associated with the transmitted event data. If so (“Yes” branch, block 816), then the event hander function is executed at block 818. If not, then the process then continues to monitor the activity between the avatar and the controller 116.

### Example Methodological Implementation

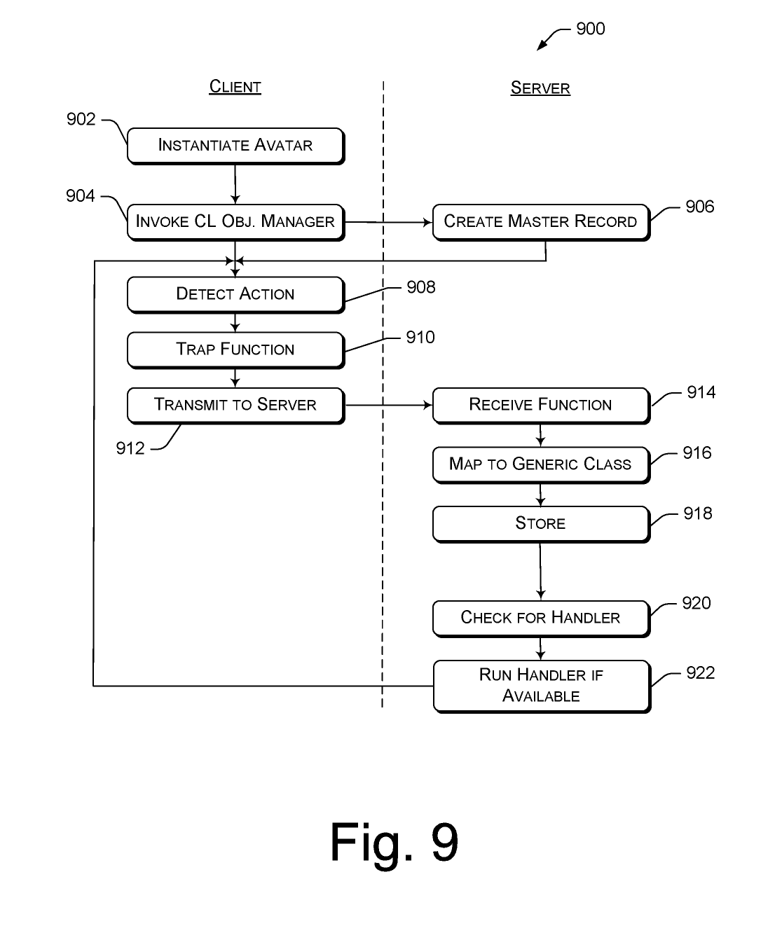

FIG. 9 is a flow diagram 900 of an example methodological implementation of a method for managing virtual/augmented reality (XR) objects. The methodological implementation described in relation to FIG. 9 is a more detailed process than described above with reference to FIG. 8, and shows operations handle by the client computing device 200 and the server 300 in this particular implementation. In the following discussion of FIG. 9, continuing reference is made to elements and reference numerals shown in and described with regard to previous figures. It is noted that, although certain operations are attributed to certain diagram boxes, those skilled in the art will recognize that some operations may be performed together with other steps shown in other boxes and that certain operations may be divided or combined. Operations shown may be performed in hardware components, software components, firmware, or a combination thereof.

At block 902, a user instantiates an avatar by way of the avatar instantiator 318. The instantiated avatar can be an avatar created from a scan performed by the user, or it may be a pre-existing avatar available through the XR Application 108 or a third-party provider. The avatar instantiation causes invocation of the tracker 216 at block 904. The tracker 216 being monitoring traffic going to and coming from the newly created avatar. The tracker 216 transmits instantiation data to the server object manager 314 at block 906. The server object manager 314 creates a new record in the avatar profiles 322 and links the new record to an appropriate user in the user profiles 320. When the tracker 216 detects an action involving the avatar (block 908), then the tracker 216 traps information related to the function that created the action (block 910) and transmits the trapped data to the server object manager 314 at block 912. The trapping operation may be accomplished by any suitable method known in the art, such as by the use of a journaling hook, a detour trampoline function, an operating system trap, reflection, etc.

At block 914, the server object manager 314 receives the transmitted data regarding the detected function. The server object manager 314 references the concordance 324 and resolves the function name of the detected function to a generic class name at block 916. An avatar identifier (from the avatar identifier field 506), the trapped function name, and the generic class name are stored in the history 326 at block 916. At block 920, the server object manager 314 determines whether there is an event handler related to the trapped function and, if so, then the identified event handler function is executed at block 922.

### Use Cases

The described techniques may be used with any suitable application that utilizes avatars. One application where the described techniques may be utilized is with a retail application. A user is able to perform a full body scan to create an avatar based on the user's body measurement. The user may then insert that avatar into an online retail application and “try on” virtual clothing using the avatar. A similar thing can be done in a real-world retail environment. A clothing retailer can set up scanning equipment in a private area, where a customer performs a body scan to create an accurately proportioned avatar based on the customer's body measurement. A retail application can then allow a user to “try on” clothing items that are available in the store. If something appears to fit, then the customer may opt to try on the tangible clothing item in the store.

Another type of application in which the described techniques may be used is a fashion show application where a user can insert an avatar that looks like them into a virtual fashion show after scanning at least their head and face. The avatar can then be dressed in virtual clothes and walked down a virtual runway. It will appear as if the user is actually appearing in a fashion show video.

A single avatar created by a user can be inserted and used in each of various applications. As a result, a user is not limited to pre-existing avatars and the user does not have to perform a scan to create an avatar for each particular application.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, comprising:
receiving a notification that an avatar has been instantiated;
creating one or more records related to the avatar;
receiving notice of a function that is performed in relation to the avatar;
mapping the received function with a generic class;
creating a history record that stores information related to the received function and the generic class to which it is mapped;
determining if the function is associated with a handler routine; and
if a handler routine is determined, executing the handler routine.

2. The method as recited in claim 1, further comprising:
identifying a user associated with the avatar; and
linking a user record with the one or more records related to the avatar.

3. The method as recited in claim 1, wherein the function that is performed in relation to the avatar further comprises a method, an event, or an attribute of a component representing the avatar.

4. The method as recited in claim 1, further comprising auditing history records related to an avatar to determine actions that have been taken in relation to the avatar.

5. The method as recited in claim 1, further comprising performing an authorization operation when certain generic class functions are invoked.

6. The method as recited in claim 1, wherein:
the mapping further comprises finding an entry in a concordance database that matches a name associated with the received function;
determining that the generic class associated with the matching entry is a generic class associated with the function name in the concordance database; and
wherein multiple function names in the concordance database are associated with a generic class in at least one instance.

7. The method as recited in claim 6, wherein each generic class in the concordance database is associated with function names from multiple applications.

8. A method, comprising:
creating an avatar for use in a virtual reality or augmented reality environment;
associating the avatar with a tracker that captures actions occurring in relation to the avatar;
when an action associated with the avatar is captured, transmitting information about the action to a computing device;
receiving information from the computing device, the information being related to a change in status of the avatar; and
rendering the avatar according to the information received from the computing device.

9. The method as recited in claim 8, wherein the creating an avatar further comprises selecting a pre-existing avatar.

10. The method as recited in claim 8, wherein the creating an avatar further comprises generating a new avatar.

11. The method as recited in claim 10, wherein the generating a new avatar further comprises capturing a three-dimensional image of a person to create an image for the new avatar.

12. The method as recited in claim 10, wherein the generating a new avatar further comprises utilizing a three-dimensional authoring tool to create the new avatar.

13. The method as recited in claim 8, wherein the computing device further comprises a remote server.

14. The method as recited in claim 8, wherein the change in status of the avatar is a change in appearance or a change in location of the avatar.

15. One or more computer-readable storage media that include computer-executable instructions that, when executed on a computer, perform the following:
receiving avatar metadata associated with an avatar;
creating an avatar profile that is associated with the avatar metadata;
receiving a function name related to a function that is performed with respect to the avatar;
mapping the function name to a generic class name; and
executing a handler routine that is associated with the function.

16. The one or more computer-readable storage media recited in claim 15, wherein the creating an avatar profile that is associated with the avatar metadata includes an identification of a user associated with the avatar.

17. The one or more computer-readable storage media recited in claim 15, further comprising additional computer-executable instructions that, when executed, create a history record that stores information related to the generic class to which the received function is mapped.

18. The one or more computer-readable storage media recited in claim 17, further comprising additional computer-executable instructions that, when executed, audit history records related to an avatar to determine actions that have been taken in relation to the avatar.

19. The one or more computer-readable storage media recited in claim 15, wherein a function performed with respect to the avatar further comprises one or more of the following: a changed attributed; a triggered event; accessed method.

20. The one or more computer-readable storage media recited in claim 15, wherein executing a handler routine that is associated with the function further comprises:
determining if a handler routine associated with the function exists; and
executing the handler routine if a handler routine exists.
